(19) United States
(12) Patent Application Publication
(10) Pub. No.: US 2023/0176580 A1
(43) Pub. Date: Jun. 8, 2023

(54) VEHICLE POSITIONING SYSTEM AND VEHICLE POSITIONING METHOD FOR CONTAINER YARD VEHICLE

(71) Applicant: INSTITUTE FOR INFORMATION INDUSTRY, Taipei City (TW)

(72) Inventors: Mao-Chi Huang, Taipei City (TW); Yung-Chih LIU, Taipei City (TW); Chih-Hsiang Ho, Taipei City (TW)

(21) Appl. No.: 17/535,374

(22) Filed: Nov. 24, 2021

(30) Foreign Application Priority Data
Oct. 18, 2021 (TW) 110138586

(51) Int. Cl. G05D 1/02; G05D 1/00

(52) U.S. Cl. CPC G05D 1/0212; G05D 1/0022; G05D 2201/0216

(57) ABSTRACT

The present invention is a vehicle positioning system and a vehicle positioning method for a container yard. The system includes a cloud server and a gate checking device. The gate checking device is communicatively connected to the cloud server, and senses a first vehicle to generate a first gate sensing signal and a second gate sensing signal. The cloud server receives and fuses the first gate sensing signal and the second gate sensing signal to generate first vehicle identity information and first vehicle positioning information. Since the present invention generates the first vehicle identity information and the first vehicle positioning information by fusing at least two sensing signals, the present invention can improve positioning accuracy and reliability by adopting a positioning technology combining multiple factors. Further, there is no need to install a transmitter or a receiver on the vehicle, improving a success rate to install the present invention.

### CROSS-REFERENCE TO RELATED APPLICATION(S)

This application claims the priority benefit of TW application serial No. 110138586 filed on Oct. 18, 2021, the entirety of which is hereby incorporated by reference herein and made a part of the specification.

### BACKGROUND OF THE INVENTION

### 1. Field of the Invention

The present invention relates to a vehicle positioning system and a vehicle positioning method, more particularly a vehicle positioning system and a vehicle positioning method for a container yard vehicle.

### 2. Description of the Related Art

In ocean freight shipping, before loading containers to a ship or after unloading containers from the ship, the containers are stored in a container yard. In a container yard, the containers must rely on special cranes to move, called “gantry cranes”, and the gantry cranes coordinate with container vehicles to operate.

In traditional container yards, the gantry cranes are operated and monitored manually. In order to reduce manpower requirements, industries are gradually introducing vehicle positioning technique and automatic scheduling systems. Conventional vehicle positioning technique often needs to install wireless signal transmitters or receivers on the container vehicles for positioning the container vehicles in the container yard.

However, due to cost, personnel coordination, equipment maintenance, and other issues, it is difficult to implement the conventional vehicle positioning technique. On the other hand, due to environmental factors of wireless transmission, positioning accuracy and reliability are difficult to improve. Therefore, the conventional vehicle positioning technique needs further improvement.

### SUMMARY OF THE INVENTION

The present invention provides a vehicle positioning system and a vehicle positioning method for a container yard vehicle. The present invention uses a positioning technique combining multiple factors to accurately track a position of the container yard vehicle without installing wireless signal transmitters or receivers.

The vehicle positioning system for the container yard vehicle includes a cloud server and a gate checking device. The gate checking device is communicatively connected to the cloud server, and senses a first container yard vehicle to generate a first gate sensing signal and a second gate sensing signal. When the cloud server receives the first gate sensing signal and the second gate sensing signal from the gate checking device, the cloud server fuses the first gate sensing signal and the second gate sensing signal to generate first vehicle identity information and first vehicle positioning information corresponding to the first container yard vehicle. A first gate signal fusing weight of the first gate sensing signal is greater than a second gate signal fusing weight of the second gate sensing signal.

Further, the vehicle positioning method for the container yard vehicle is executed by the cloud server, and includes steps of: receiving the first gate sensing signal and the second gate sensing signal from the gate checking device; fusing the first gate sensing signal and the second gate sensing signal to generate first vehicle identity information and first vehicle positioning information corresponding to the first container yard vehicle; wherein the first gate signal fusing weight of the first gate sensing signal is greater than the second gate signal fusing weight of the second gate sensing signal.

The present invention fuses the first gate sensing signal and the second gate sensing signal to generate the first vehicle identity information and the first vehicle positioning information, and the position of the first container yard vehicle can be determined by the first vehicle identity information and the first vehicle positioning information. Therefore, an automatic scheduling system of a gantry crane can schedule hanging operations of containers according to the position of the first container yard vehicle to improve work efficiency. Moreover, the present invention fuses at least two sensing signals to generate identity information and positioning information. Namely, the present invention combines multiple factors by data fusion to improve positioning accuracy and positioning reliability without installing transmitters or receivers. Therefore, the present invention can be easily implemented.

### BRIEF DESCRIPTION OF THE DRAWINGS

FIG. is a block diagram of a vehicle positioning system for a container yard vehicle of the present invention.

FIG. 2 is a flowchart of a vehicle positioning method for the container yard vehicle of the present invention.

FIG. 3 is a schematic diagram of a gate checking device of the vehicle positioning system for the container yard vehicle of the present invention.

FIG. 4A and FIG. 4B are another flowchart of the vehicle positioning method for the container yard vehicle of the present invention.

FIG. 5 is a schematic diagram of a queuing area checking device of the vehicle positioning system for the container yard vehicle of the present invention.

FIG. 6 is still another flowchart of the vehicle positioning method for the container yard vehicle of the present invention.

FIG. 7 is a schematic diagram of a gantry crane checking device of the vehicle positioning system for the container yard vehicle of the present invention.

FIG. 8 is a schematic diagram of driving lane recognition of the vehicle positioning system for the container yard vehicle of the present invention.

### DETAILED DESCRIPTION OF THE INVENTION

With reference to FIG. 1, a vehicle positioning system for a container yard vehicle 100 includes a cloud server 10, a gate checking device 20, a mobile device 30, a queuing area checking device 40, and a gantry crane checking device 50. The gate checking device is communicatively connected to the cloud server 10, and senses a first container yard vehicle to generate a first gate sensing signal and a second gate sensing signal.

When the cloud server 10 receives the first gate sensing signal and the second gate sensing signal from the gate checking device 20, the cloud server 10 fuses the first gate sensing signal and the second gate sensing signal to generate first vehicle identity information and first vehicle positioning information corresponding to the first container yard vehicle. A first gate signal fusing weight of the first gate sensing signal is greater than a second gate signal fusing weight of the second gate sensing signal.

The gate checking device further senses the first container yard vehicle to generate a third gate sensing signal. The cloud server 10 receives the third gate sensing signal, and fuses the first gate sensing signal, the second gate sensing signal, and the third gate sensing signal to generate the first vehicle identity information and the first vehicle positioning information corresponding to the first container yard vehicle.

The first gate signal fusing weight and the second gate signal fusing weight are greater than the third gate signal fusing weight.

Moreover, the mobile device 30 is communicatively connected to the cloud server 10, and generates a positioning signal.

When the cloud server 10 receives the positioning signal from the mobile device 30, the cloud server 10 fuses the first gate sensing signal, the second gate sensing signal, and the positioning signal to generate the first vehicle identity information and the first vehicle positioning information corresponding to the first container yard vehicle. The first gate signal fusing weight is greater than a positioning signal fusing weight of the positioning signal, and the second gate signal fusing weight is greater than the positioning signal fusing weight.

When the cloud server 10 receives the positioning signal from the mobile device 30, the cloud server 10 may further fuse the first gate sensing signal, the second gate sensing signal, the third gate sensing signal, and the positioning signal to generate the first vehicle identity information and the first vehicle positioning information corresponding to the first container yard vehicle. The third gate signal fusing weight is greater than the positioning signal fusing weight.

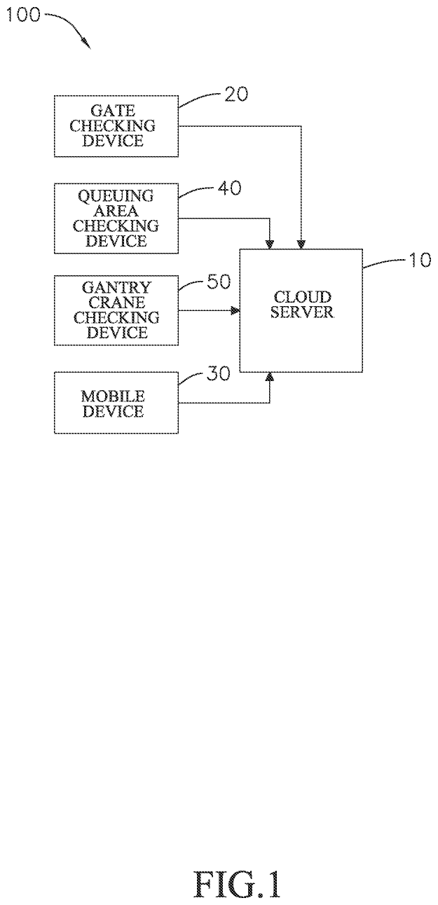

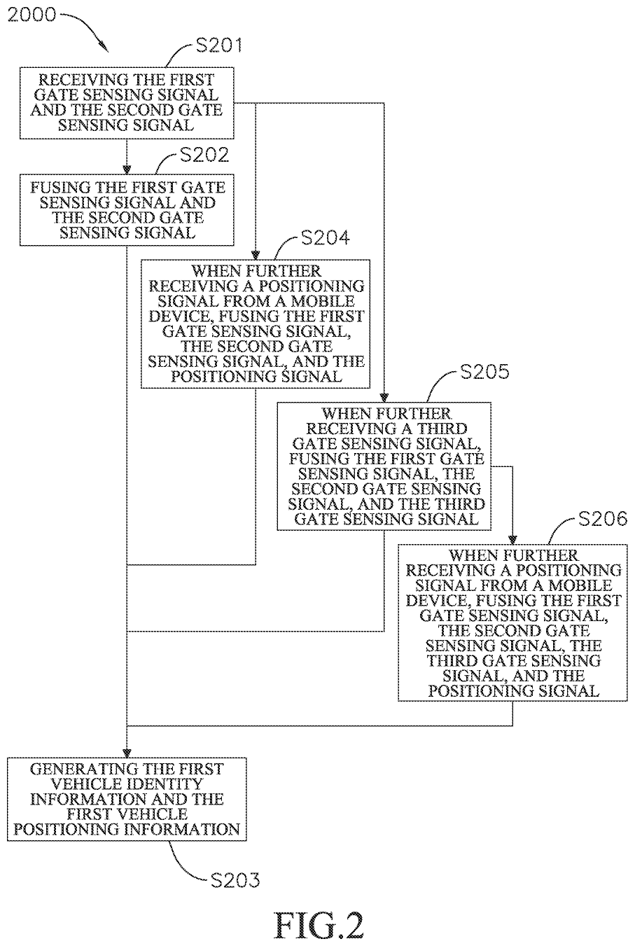

With reference to FIG. 2, a vehicle positioning method for the container yard vehicle 2000 is executed by the cloud server 10, and includes steps of: step S201: receiving the first gate sensing signal and the second gate sensing signal from the gate checking device 20; step S202: fusing the first gate sensing signal and the second gate sensing signal; step S203: generating the first vehicle identity information and the first vehicle positioning information corresponding to the first container yard vehicle; wherein the first gate signal fusing weight is greater than the second gate signal fusing weight.

When the cloud server 10 further receives the positioning signal from the mobile device 30 after step S201, step S204 is executed. In step S204, the cloud server 10 fuses the first gate sensing signal, the second gate sensing signal, and the positioning signal.

When the cloud server 10 further receives the third gate sensing signal from the gate checking device after step S201, step S205 is executed. In step S205, the cloud server 10 fuses the first gate sensing signal, the second gate sensing signal, and the third gate sensing signal. The second gate signal fusing weight is greater than the third gate signal fusing weight.

When the cloud server 10 further receives the positioning signal from the mobile device 30 after step S205, step S206 is executed. In step S206, the cloud server 10 fuses the first gate sensing signal, the second gate sensing signal, the third gate sensing signal, and the positioning signal. The first gate signal fusing weight, the second gate signal fusing weight, and the third gate signal fusing weight are greater than the positioning signal fusing weight.

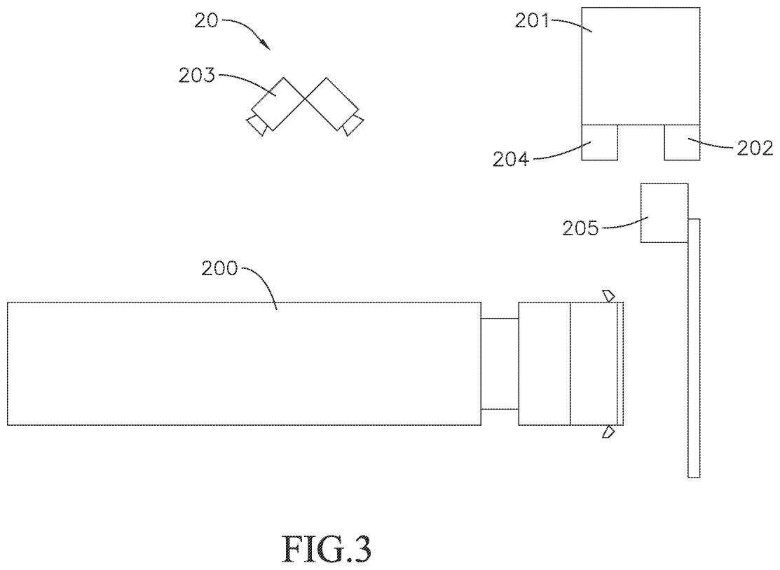

The present invention is used to sense the container yard vehicle driving into the container yard, and to position the container yard vehicle. With reference to FIG. 3, the gate checking device is mounted at an entrance of the container yard to control vehicles entering or exiting the container yard. Namely, each of the vehicles has to stop at a gate of the entrance of the container yard, and each of the vehicle drivers has to check in at the gate. The gate checking device 20 includes multiple sensors to sense the vehicles stopping at the gate for generating multiple sensing signals. The gate checking device uploads the sensing signals to the cloud server 10 for confirmation, and the cloud server 10 will generate vehicle identity information for positioning the vehicles.

For example, the gate checking device senses the first container yard vehicle driving into the container yard, and generates the first gate sensing signal and the second gate sensing signal. Then, the cloud server 10 fuses the first gate sensing signal and the second gate sensing signal to generate the first vehicle identity information and the first vehicle positioning information for positioning the first container yard vehicle. Therefore, a position of the first container yard vehicle can be determined, and an automatic scheduling system of a gantry crane can schedule hanging operations of contains according to the position of the first container yard vehicle to improve work efficiency.

Moreover, the present invention fuses at least two sensing signals, such as the first gate sensing signal and the second gate sensing signal, to generate the first vehicle identity information and the first vehicle positioning information. Namely, the first positioning information is determined by fusing data, and by combining multiple factors. Therefore, accuracy and reliability of the position of the first container yard vehicle can be improved, and without installing transmitters or receivers, success rate for implementing the present invention can be also improved.

The gate checking device further senses the third gate sensing signal to increase the factors for positioning the first container yard vehicle. Therefore, the accuracy and the reliability can be further improved.

In an embodiment, the positioning signal of the mobile device 30 may be, but is not limited to, a Global Positioning System (GPS) signal. The mobile device 30 is carried by the driver of the first container yard vehicle. Therefore, a position of the mobile device 30 is same as the position of the first container yard vehicle, and the cloud server 10 can determine the position of the first container yard vehicle according to the positioning signal uploaded by the mobile device 30.

With reference to FIG. 3, for example, the gate checking device includes multiple sensors to sense the first container yard vehicle stopping at the gate of the entrance of the container yard for generating multiple sensing signals. The gate checking device uploads the sensing signals to the cloud server 10, and the cloud server 10 can determine types of effective sensors according to the sensing signals uploaded by the gate checking device 20. Since the cloud server 10 presets information of the vehicles entering or exiting the container yard in a database, such as license plate, vehicle body image, or driver information, the cloud server 10 can determine information corresponding to the driver and the first container yard vehicle according to the sensing signals uploaded by the gate checking device 20. The cloud server 10 further generates the first vehicle identity information and the first vehicle positioning information according to the information corresponding to the driver and the first container yard vehicle, thereby determining that the first container yard vehicle is located at the gate checking device 20.

For example, the gate checking device includes a checking host 201, and the driver can check in at the checking host 201. The gate checking device 20 further includes a Radio Frequency identification (RFID) sensor 202, and the RFID sensor 202 senses an electronic tag (eTag) on the first container yard vehicle 200. The gate checking device can include an image sensor 203 and a fill light. The fill light can lighten a vehicle body of the first container yard vehicle 200, such as vehicle front or vehicle rear, and the image sensor 203 can capture images of the vehicle front or the vehicle rear. The gate checking device can further include a beacon sensor 204, such as a Bluetooth sensor, to sense the mobile device 30 of the driver.

The sensing signals that can be sensed by the gate checking device 20 are used to determine that the first container yard vehicle 200 can be positioned by the sensing signals. Further, the sensors of the gate checking device 20 that can sense signals can be determined to be the effective sensors.

For example, the RFID sensor 202 can be used to determine whether the first container yard vehicle 200 installs the eTag. When the RFID sensor 202 can sense the sensing signal, the RFID sensor 202 is determined to be the effective sensor. The image sensor 203 can capture the images of the vehicle front or the vehicle rear. The images can be processed by an AI module to capture feature points of the images to determine the first vehicle identity information of the first container yard vehicle 200. The beacon sensor 204 can be used to determine whether the driver checks in with the mobile device 30. When the driver checks in with the mobile device 30, the beacon sensor 204 is determined to be the effective sensor and can determine that the driver carries the mobile device 30. Further, the cloud server 10 can determine the position of the first container yard vehicle 200 according to the positioning signal, such as a Global Positioning System (GPS) signal, transmitted by the mobile device 30.

In the embodiment, the first gate sensing signal is a RFID signal, the second gate sensing signal is an image signal, the third gate sensing signal is a Bluetooth signal, and the positioning signal is a GPS signal.

After the driver finishes a check-in process, the gate checking device 20 opens a barrier gate, and the first container yard vehicle 200 can enter the container yard.

Moreover, multiple sensors can be separately installed at multiple areas in the container yard. For example, the RFID sensor, the image sensor, and the beacon sensor can be installed at an important intersection. When the first container yard vehicle 200 drives through the important intersection, the sensors can sense the first container yard vehicle 200, and upload the sensing signals to the cloud server 10. The cloud server 10 can determine the first identity information of the first container yard vehicle 200, and the cloud server 10 can determine the first positioning information according to a location of the important intersection.

The cloud server 10 further stores map information of a road network of the container yard. When the cloud server 10 receives the GPS signal from the mobile device 30, the cloud server 10 can further position the first positioning information in a lane according to the map information for increasing accuracy of the first positioning information.

Therefore, the vehicle positioning system for the container yard vehicle 100 can accurately position the first container yard vehicle 200, and an automatic scheduling system of a gantry crane can schedule hanging operations of containers according to the position of the first container yard vehicle 20 to improve work efficiency.

With reference to FIG. 1, the queuing area checking device 40 of the vehicle positioning system for the container yard vehicle 100 is communicatively connected to the cloud server 10, and senses a second container yard vehicle to generate a first queuing area sensing signal and a second queuing area sensing signal. When the cloud server 10 receives the first queuing area sensing signal and the second queuing area sensing signal from the queuing area checking device 40, the cloud server 10 fuses the first queuing area sensing signal and the second queuing area sensing signal to generate second vehicle identity information for determining whether the second vehicle identity information is the first vehicle identity information, and for determining whether the second container yard vehicle is positioned in a lane. When the second vehicle identity information is the first vehicle identity information and the second container yard vehicle is positioned in the lane, the cloud server 10 transmits a notification signal to the automatic scheduling system of the gantry crane for scheduling. A first queuing area signal fusing weight of the first queuing area sensing signal is greater than a second queuing area signal fusing weight of the second queuing area sensing signal.

The queuing area checking device 40 further senses the second container yard vehicle to generate a third queuing area sensing signal, and transmits the third queuing area sensing signal to the cloud server 10. The cloud server 10 fuses the first queuing area sensing signal, the second queuing area sensing signal, and the third queuing area sensing signal for determining whether the second vehicle identity information is the first vehicle identity information, and for determining whether the second container yard vehicle is positioned in the lane. When the second vehicle identity information is the first vehicle identity information and the second container yard vehicle is positioned in the lane, the cloud server 10 transmits the notification signal to the automatic scheduling system of the gantry crane for scheduling. The first queuing area signal fusing weight and the second queuing area signal fusing weight are greater than a third queuing area signal fusing weight of the third queuing area sensing signal.

When the cloud server 10 further receives the positioning signal from the mobile device 30, the cloud server 10 fuses the first queuing area sensing signal, the second queuing area sensing signal, and the positioning signal for determining whether the second vehicle identity information is the first vehicle identity information, and for determining whether the second container yard vehicle is positioned in the lane. When the second vehicle identity information is the first vehicle identity information and the second container yard vehicle is positioned in the lane, the cloud server 10 transmits the notification signal to the automatic scheduling system of the gantry crane for scheduling. The first queuing area signal fusing weight and the second queuing area signal fusing weight are greater than the positioning signal fusing weight.

When the cloud server 10 receives the positioning signal from the mobile device 30, the cloud server 10 further fuses the first queuing area sensing signal, the second queuing area sensing signal, and the positioning signal for determining whether the second vehicle identity information is the first vehicle identity information, and for determining whether the second container yard vehicle is positioned in the lane. When the second vehicle identity information is the first vehicle identity information and the second container yard vehicle is positioned in the lane, the cloud server 10 transmits the notification signal to the automatic scheduling system of the gantry crane for scheduling. The third queuing area signal fusing weight is greater than the positioning signal fusing weight.

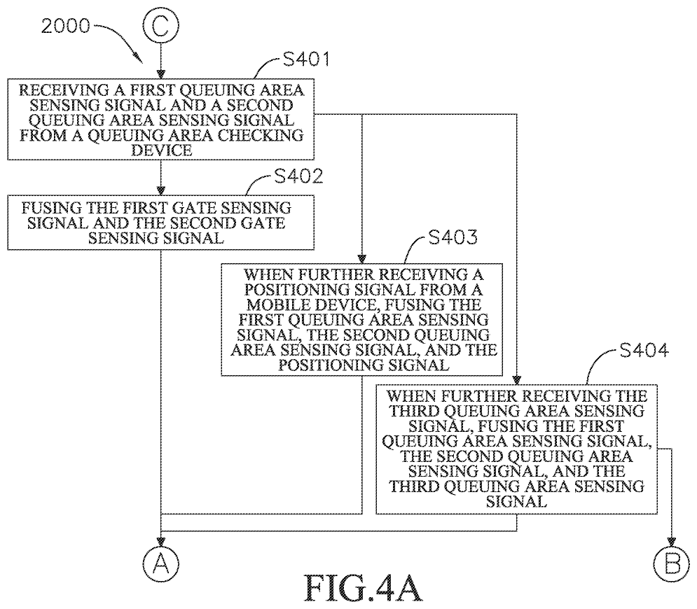

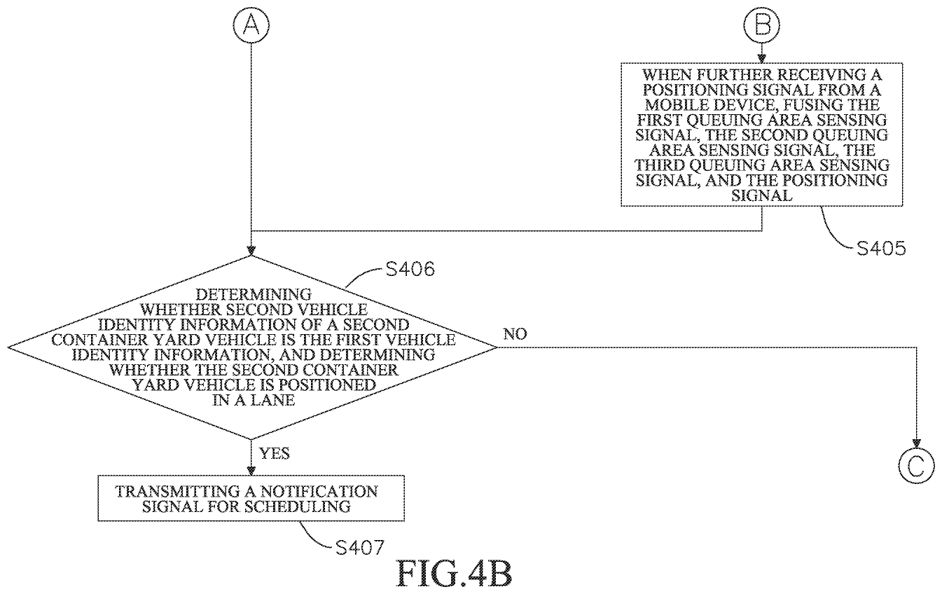

With reference to FIG. 4A and FIG. 4B, the vehicle positioning method for the container yard vehicle 2000 further includes steps of: step S401: receiving the first queuing area sensing signal and the second queuing area sensing signal from the queuing area checking device 40; step S202: fusing the first queuing area sensing signal and the second queuing area sensing signal. When the cloud server 10 further receives the positioning signal after step S401, step S403 is executed. In step S403, the cloud server 10 fuses the first queuing area sensing signal, the second queuing area sensing signal, and the positioning signal. When the cloud server 10 further receives the third queuing area sensing signal after step S401, step S404 is executed. In step S404, the cloud server 10 fuses the first queuing area sensing signal, the second queuing area sensing signal, and the third queuing area sensing signal. When the cloud server 10 further receives the positioning signal after step S404, step S405 is executed. In step S405, the cloud server 10 fuses the first queuing area sensing signal, the second queuing area sensing signal, the third queuing area sensing signal, and the positioning signal.

After the cloud server 10 fuses the first queuing area sensing signal, the second queuing area sensing signal, the third queuing area sensing signal, or the positioning signal, step S406 is executed. In step S406, determining whether the second vehicle identity information is the first vehicle identity information, and for determining whether the second container yard vehicle is positioned in the lane according to a result of fusing the first queuing area sensing signal, the second queuing area sensing signal, the third queuing area sensing signal, or the positioning signal. If yes, step S407 is executed. In step S407, transmitting the notification signal to the automatic scheduling system of the gantry crane for scheduling. If no, step S401 is executed.

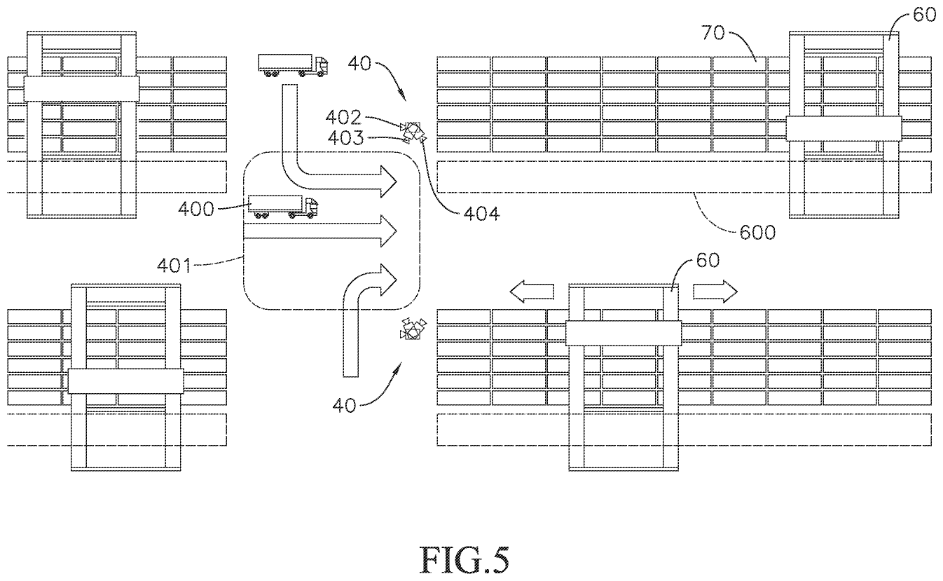

With reference to FIG. 5, the queuing area checking device 40 is mounted in the container yard, and at a queuing area 401 near a gantry crane 60. For example, the queuing area 401 is an intersection near the gantry crane 60. The queuing area checking device 40 can be mounted at a corner of the intersection near the gantry crane 60 to sense a second container yard vehicle 400 stopped in the queuing area 401. Before the second container yard vehicle 400 enters an operating area 600 of the gantry crane 60, the second container yard vehicle 400 needs to stop at the intersection near the gantry crane 60 for waiting queuing into the operating area 600.

The queuing area checking device 40 includes multiple sensors to sense the second container yard vehicle 400 in the queuing area 401 for generating multiple sensing signals. The queuing area checking device 40 uploads the sensing signals to the cloud server 10 for determining the effective sensors. When the cloud server 10 receives the sensing signals from the queuing area checking device 40, the cloud server 10 can generate the second vehicle identity information corresponding to the second container yard vehicle 400. When the second vehicle identity information is the first vehicle identity information, the cloud server 10 can determine that the second container yard vehicle 400 has checked in at the gate checking device 20. The cloud server 10 then transmits the notification signal to the automatic scheduling system of the gantry crane for scheduling. Namely, the first container yard vehicle 200 has driven to the queuing area 401, has finished a check-in operation, and prepares for hanging operations of the gantry crane 60.

For example, the queuing area checking device 40 includes a RFID sensor 402 sensing the eTag on the second container yard vehicle 400. The queuing area checking device 40 further includes an image sensor 403 and a fill light. The fill light can lighten a vehicle front or a vehicle rear of the second container yard vehicle 400, and the image sensor 403 can capture images of the vehicle front or the vehicle rear. The queuing area checking device 40 can further include a beacon sensor 404, such as a Bluetooth sensor, to sense the mobile device 30 of the driver.

In the embodiment, the first queuing area sensing signal is a RFID signal, the second queuing area sensing signal is an image signal, and the third queuing area sensing signal is a Bluetooth signal.

With reference to FIG. 1, the gantry crane checking device 50 of the vehicle positioning system for the container yard vehicle 100 is communicatively connected to the cloud server 10, and senses a third container yard vehicle to generate a first gantry crane sensing signal and a second gantry crane sensing signal. When the cloud server 10 receives the first gantry crane sensing signal and the second gantry crane sensing signal from the gantry crane checking device 50, the cloud server 10 fuses the first gantry crane sensing signal and the second gantry crane sensing signal to generate third vehicle identity information for determining whether the third vehicle identity information is the first vehicle identity information. When the third vehicle identity information is the first vehicle identity information, the cloud server 10 transmits the notification signal to the automatic scheduling system of the gantry crane for scheduling. A first gantry crane signal fusing weight of the first gantry crane sensing signal is greater than a second gantry crane signal fusing weight of the second gantry crane sensing signal.

When the cloud server 10 further receives the positioning signal from the mobile device 30, the cloud server 10 fuses the first gantry crane sensing signal, the second gantry crane sensing signal, and the positioning signal for determining whether the third vehicle identity information is the first vehicle identity information. When the third vehicle identity information is the first vehicle identity information, the cloud server 10 transmits the notification signal to the automatic scheduling system of the gantry crane for scheduling. The first gantry crane signal fusing weight and the second gantry crane signal fusing weight are greater than the positioning signal fusing weight.

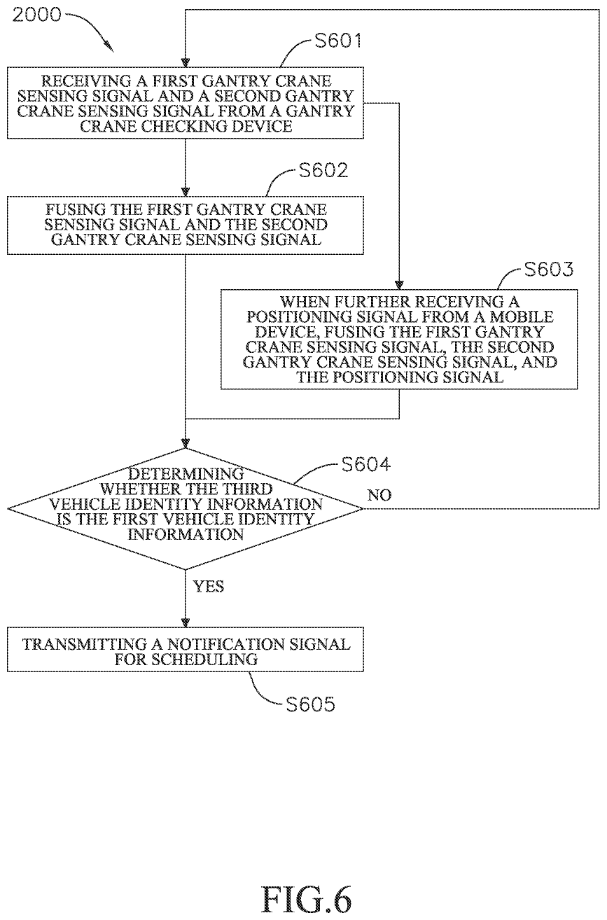

With reference to FIG. 6, the vehicle positioning method for the container yard vehicle 2000 further includes steps of: step S601: receiving the first gantry crane sensing signal and the second gantry crane sensing signal from the gantry crane checking device 50; step S202: fusing the first gantry crane sensing signal and the second gantry crane sensing signal. When the cloud server 10 further receives the positioning signal after step S601, step S603 is executed. In step S603, the cloud server 10 fuses the first gantry crane sensing signal, the second gantry crane sensing signal, and the positioning signal.

After the cloud server 10 fuses the first gantry crane sensing signal, the second gantry crane sensing signal, or the positioning signal, step S604 is executed. In step S604, determining whether the third vehicle identity information is the first vehicle identity information according to a result of fusing the first gantry crane sensing signal, the second gantry crane sensing signal, or the positioning signal. If yes, step S605 is executed. In step S605, transmitting the notification signal to the automatic scheduling system of the gantry crane for scheduling. If no, step S601 is executed.

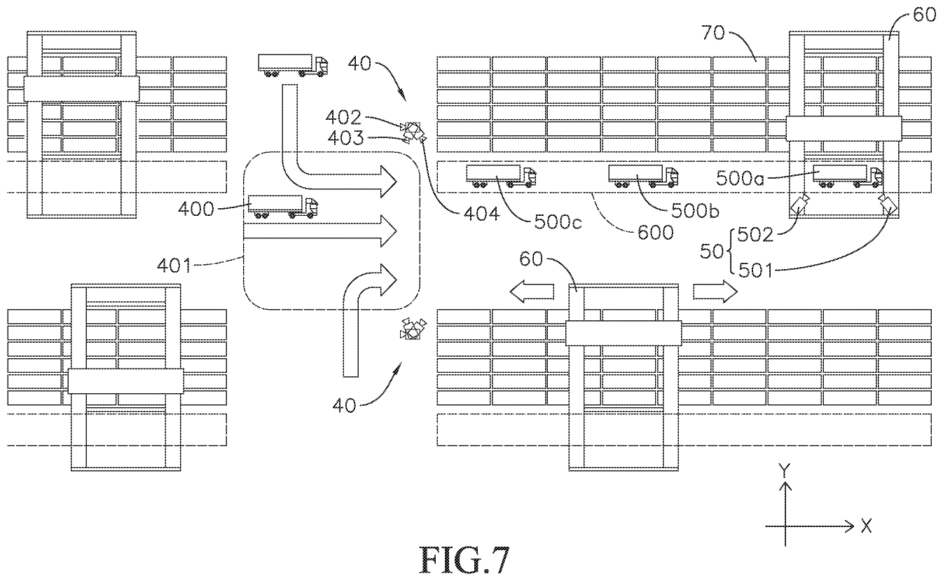

With reference to FIG. 7, the gantry crane checking device 50 is mounted on the gantry crane 60, and the gantry crane 60 includes a positioning device, such as a GPS device. The positioning device of the gantry crane 60 transmits a positioning signal of the gantry crane 60 to the cloud server 10, and the cloud server 10 can determine a position of the gantry crane 60 according to the positioning signal of the gantry crane 60. For example, the gantry crane 60 moves along with the X axis. When the gantry crane 60 is moving, the gantry crane checking device 50 mounted on the gantry crane 60 can sequentially sense the third container yard vehicles 500a, 500b, 500c located in the operating area 600 of the gantry crane 60. The gantry crane checking device 50 then can respectively generate the first gantry crane sensing signals and the second gantry crane sensing signals corresponding to the third container yard vehicles 500a, 500b, 500c, and the cloud server 10 can determine positions of the third container yard vehicles 500a, 500b, 500c. Namely, the third container yard vehicles 500a, 500b, 500c each can be sensed by the gantry crane checking device 50.

The cloud server 10 further compares the positioning signal of the gantry crane 60 and the positioning of the mobile device 30 to determine the precise positions of the third container yard vehicles 500a, 500b, 500c in the operating area 600 of the gantry crane 60 for improving the position information corresponding to the third container yard vehicles 500a, 500b, 500c. The automatic scheduling system of the gantry crane 60 then can schedule the hanging operations of the containers 70 according to the position information of the third container yard vehicles 500a, 500b, 500c.

The gantry crane checking device 50 includes multiple sensors to sense the third container yard vehicles 500a, 500b, 500c in the operating area 600 of the gantry crane 60 for generating multiple sensing signals. The gantry crane checking device 50 uploads the sensing signals to the cloud server 10 for determining the effective sensors. When the cloud server 10 receives the sensing signals from the gantry crane checking device 50, the cloud server 10 can generate the third vehicle identity information corresponding to the third container yard vehicles 500a, 500b, 500c. When the third vehicle identity information is the first vehicle identity information, the cloud server 10 can determine that the third container yard vehicles 500a, 500b, 500c have checked-in at the gate checking device 20. The cloud server 10 then transmits the notification signal to the automatic scheduling system of the gantry crane for scheduling. Namely, the first container yard vehicle 200 has driven to the operating area 600 of the gantry crane 60, and waits for the gantry crane 60 to process the hanging operations of the containers 70.

For example, the gantry crane checking device 50 includes an image sensor 501 and a fill light. The fill light can lighten vehicle fronts or vehicle rears of the third container yard vehicles 500a, 500b, 500c, and the image sensor 501 can capture images of the vehicle fronts or the vehicle rears. The gantry crane checking device 50 further includes a beacon sensor 502, such as a Bluetooth sensor, to sense the mobile device 30 of the driver.

In the embodiment, the first gantry crane sensing signal is an image signal, and the second gantry crane sensing signal is a Bluetooth signal.

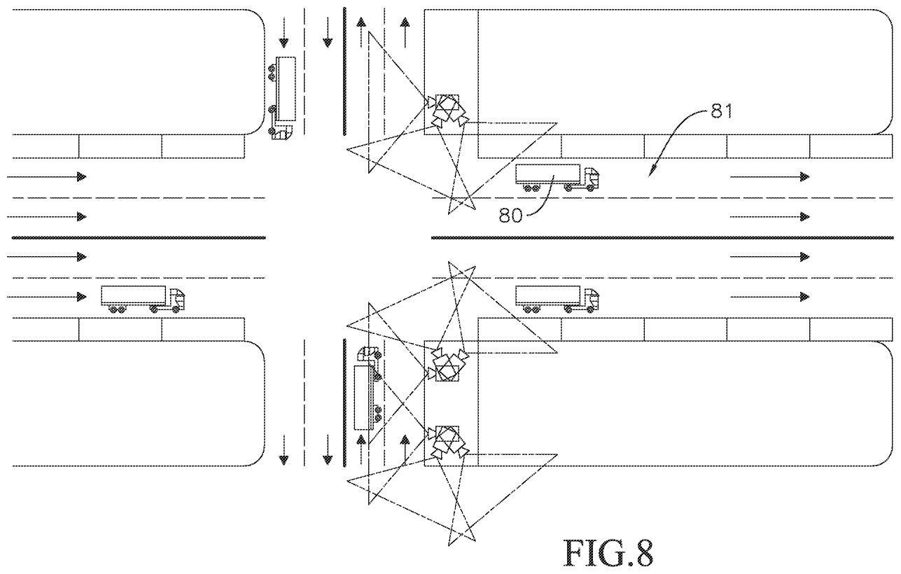

With reference to FIG. 8, when the sensing signal received by the cloud server 10 is the image signal, the cloud server 10 can further determine whether the vehicles 80 driving in the lane 81 is a waiting vehicle waiting for driving into the operating area or a passing vehicle. For example, the cloud server 10 can preset a particular area in the image signal as an area of the lane 81. When the vehicle 80 in the image is located in the area of the lane 81, the cloud server 10 determines that the vehicle 80 is driving in the lane 81, and the vehicle 80 driving in the lane 81 is the passing vehicle.

Overall, a vehicle entering the container yard needs to pass through the gate of the container yard. The gate checking device can sense the vehicle, and a driver of the vehicle can check in at the gate checking device 20. Since the gate checking device includes multiple sensors, the gate checking device senses the vehicle to generate multiple sensing signals and upload the sensing signals to the cloud server 10. The cloud server 10 then determines identity information of the vehicle, and fuses the sensing signals to determine positioning information of the vehicle. The cloud server 10 can further determine types of effective sensors according to the sensing signals.

For example, when the cloud server 10 just receives the first gate sensing signal and the second gate sensing signal, the first gate signal fusing weight is 0.6, and the second gate signal fusing weight is 0.4. When the cloud server 10 just receives the first gate sensing signal, the second gate sensing signal, and the third gate sensing signal, the first gate signal fusing weight is 0.6, the second gate signal fusing weight is 0.3, and the third gate signal fusing weight is 0.1. When the cloud server 10 just receives the first gate sensing signal, the second gate sensing signal, and the positioning signal, the first gate signal fusing weight is 0.6, the second gate signal fusing weight is 0.3, and the positioning signal fusing weight is 0.1. When the cloud server 10 receives the first gate sensing signal, the second gate sensing signal, the third gate sensing signal, and the positioning signal, the first gate signal fusing weight is 0.6, the second gate signal fusing weight is 0.2, the third gate signal fusing weight is 0.and the positioning signal fusing weight is 0.1. The above mentioned are only examples, and the present invention is not limited thereto.

When the cloud server 10 receives the sensing signals from the queuing area checking device 40 in good weather, the cloud server 10 fuses the first queuing area sensing signal, the second queuing area sensing signal, the third queuing area sensing signal, and the positioning signal. When the cloud server 10 receives sensing signals from the queuing area checking device 40 on a rainy day, since the Bluetooth signal is interfered with rain, the cloud server 10 just fuses the first queuing area sensing signal, the second queuing area sensing signal, and the positioning signal. When the cloud server 10 receives sensing signals from the queuing area checking device 40 on a fogged day, since the image signal is interfered with fog, the cloud server 10 just fuses the first queuing area sensing signal, the third queuing area sensing signal, and the positioning signal. When the cloud server 10 receives sensing signals from the queuing area checking device 40 on a clouded day, since the GPS signal is interfered with clouds, the cloud server 10 just fuses the first queuing area sensing signal, the second queuing area sensing signal, and the third queuing area sensing signal.

If the driver does not use the mobile device 30 to check in, the cloud server 10 cannot receive the third queuing area sensing signal from the queuing area checking device 40 and the positioning signal from the mobile device 30. The cloud server 10 just fuses the first queuing area sensing signal and the second queuing area sensing signal.

If the vehicle does not have the eTag or there is no eTag being detected, the cloud server 10 cannot receive the first queuing area sensing signal. The cloud server 10 just fuses the second queuing area sensing signal, the third queuing area sensing signal, and the positioning signal.

For example, when the cloud server 10 just receives the first queuing area sensing signal and the second queuing area sensing signal, the first queuing area signal fusing weight is 0.6, and the second queuing area signal fusing weight is 0.4. When the cloud server 10 just receives the first queuing area sensing signal, the second queuing area sensing signal, and the third queuing area sensing signal, the first queuing area signal fusing weight is 0.6, the second queuing area signal fusing weight is 0.3, and the third queuing area signal fusing weight is 0.1. When the cloud server 10 just receives the first queuing area sensing signal, the second queuing area sensing signal, and the positioning signal, the first queuing area signal fusing weight is 0.6, the second queuing area signal fusing weight is 0.3, and the positioning signal fusing weight is 0.1. When the cloud server 10 receives the first queuing area sensing signal, the second queuing area sensing signal, the third queuing area sensing signal, and the positioning signal, the first queuing area signal fusing weight is 0.6, the second queuing area signal fusing weight is 0.2, the third queuing area signal fusing weight is 0.1 and the positioning signal fusing weight is 0.1. The above mentioned are only examples, and the present invention is not limited thereto.

The gantry crane checking device 50 is unable to install the RFID sensor due to technical limitations. Therefore, when the cloud server 10 receives the sensing signals from the gantry crane checking device 50 in good weather, the cloud server 10 fuses the first gantry crane sensing signal, the second gantry crane sensing signal, and the positioning signal. When the cloud server 10 receives sensing signals from the gantry crane checking device 50 on a rainy day, the cloud server 10 still fuses the first gantry crane sensing signal, the second gantry crane sensing signal, and the positioning signal. When the cloud server 10 receives sensing signals from the gantry crane checking device 50 on a fogged day, since the image signal is interfered with fog, the cloud server 10 just fuses the first gantry crane sensing signal and the positioning signal. When the cloud server 10 receives sensing signals from the gantry crane checking device 50 on a clouded day, since the GPS signal is interfered with clouds, the cloud server 10 just fuses the first gantry crane sensing signal and the second gantry crane sensing signal.

If the driver does not use the mobile device 30 to check in, the cloud server 10 cannot receive the second gantry crane sensing signal from the gantry crane checking device 50 and the positioning signal from the mobile device 30. The cloud server 10 positions the vehicle according to the first gantry crane sensing signal.

If the vehicle does not have the eTag or there in no eTag being detected, the gantry crane checking device 50 is unaffected. The cloud server 10 can fuse the first gantry crane sensing signal, the second gantry crane sensing signal, and the positioning signal.

For example, when the cloud server 10 just receives the first gantry crane sensing signal and the second gantry crane sensing signal, the first gantry crane signal fusing weight is 0.6, and the second gantry crane signal fusing weight is 0.4. When the cloud server 10 just receives the first gantry crane sensing signal, the second gantry crane sensing signal, and the positioning sensing signal, the first gantry crane signal fusing weight is 0.6, the second gantry crane signal fusing weight is 0.3, and the positioning signal fusing weight is 0.1. The above mentioned are only examples, and the present invention is not limited thereto.

In summary, the present invention generates the vehicle identity information and the vehicle positioning information by fusing at least two sensing signals. Namely, the present invention combines multiple factors by data fusion to improve positioning accuracy and positioning reliability without installing transmitters or receivers. Therefore, the present invention can be easily implemented.

The above details only a few embodiments of the present invention, rather than imposing any forms of limitation to the present invention. Any professionals in related fields of expertise relating to the present invention, within the limitations of what is claimed, are free to make equivalent adjustments regarding the embodiments mentioned above. However, any simple adjustments and equivalent changes made without deviating from the present invention would be encompassed by what is claimed for the present invention.

What is claimed is:

1. A vehicle positioning system for a container yard vehicle, comprising:
a cloud server; and
a gate checking device, communicatively connected to the cloud server, and sensing a first container yard vehicle to generate a first gate sensing signal and a second gate sensing signal;
wherein when the cloud server receives the first gate sensing signal and the second gate sensing signal from the gate checking device, the cloud server fuses the first gate sensing signal and the second gate sensing signal to generate first vehicle identity information and first vehicle positioning information corresponding to the first container yard vehicle;
wherein a first gate signal fusing weight of the first gate sensing signal is greater than a second gate signal fusing weight of the second gate sensing signal.

2. The vehicle positioning system for the container yard vehicle as claimed in claim 1, wherein the gate checking device further senses the first container yard vehicle to generate a third gate sensing signal;
wherein when the cloud server further receives the third gate sensing signal, the cloud server fuses the first gate sensing signal, the second gate sensing signal, and the third gate sensing signal to generate the first vehicle identity information and the first vehicle positioning information;
wherein the first gate signal fusing weight and the second gate signal fusing weight are greater than a third gate signal fusing weight of the third gate sensing signal.

3. The vehicle positioning system for the container yard vehicle as claimed in claim 1, further comprising:
a queuing area checking device, communicatively connected to the cloud server, and sensing a second container yard vehicle to generate a first queuing area sensing signal and a second queuing area sensing signal;
wherein when the cloud server receives the first queuing area sensing signal and the second queuing area sensing signal from the queuing area checking device, the cloud server fuses the first queuing area sensing signal and the second queuing area sensing signal to generate second vehicle identity information for determining whether the second vehicle identity information is the first vehicle identity information, and for determining whether the second container yard vehicle is positioned in a lane;
wherein when the second vehicle identity information is the first vehicle identity information and the second container yard vehicle is positioned in the lane, the cloud server transmits a notification signal for scheduling;
wherein a first queuing area signal fusing weight of the first queuing area sensing signal is greater than a second queuing area signal fusing weight of the second queuing area sensing signal.

4. The vehicle positioning system for the container yard vehicle as claimed in claim 3, wherein the queuing area checking device further senses the second container yard vehicle to generate a third queuing area sensing signal;
wherein the cloud server further receives the third queuing area sensing signal, the cloud server fuses the first queuing area sensing signal, the second queuing area sensing signal, and the third queuing area sensing signal for determining whether the second vehicle identity information is the first vehicle identity information;
wherein when the second vehicle identity information is the first vehicle identity information, the cloud server transmits the notification signal for scheduling;
wherein the first queuing area signal fusing weight and the second queuing area signal fusing weight are greater than a third queuing area signal fusing weight of the third queuing area sensing signal.

5. The vehicle positioning system for the container yard vehicle as claimed in claim 1, further comprising:
a gantry crane checking device, communicatively connected to the cloud server, and sensing a third container yard vehicle to generate a first gantry crane sensing signal and a second gantry crane sensing signal;
wherein when the cloud server receives the first gantry crane sensing signal and the second gantry crane sensing signal from the gantry crane checking device, the cloud server fuses the first gantry crane sensing signal and the second gantry crane sensing signal to generate third vehicle identity information for determining whether third vehicle identity information is the first vehicle identity information;
wherein when the third vehicle identity information is the first vehicle identity information, the cloud server transmits the notification signal for scheduling;
wherein a first gantry crane signal fusing weight of the first gantry crane sensing signal is greater than a second gantry crane signal fusing weight of the second gantry crane sensing signal.

6. The vehicle positioning system for the container yard vehicle as claimed in claim 1, further comprising:
a mobile device, communicatively connected to the cloud server, and generating a positioning signal;
wherein when the cloud server further receives the positioning signal from the mobile device, the cloud server fuses the first gate sensing signal, the second gate sensing signal, and the positioning signal to generate the first vehicle identity information and the first vehicle positioning information;
wherein the first gate signal fusing weight and the second gate signal fusing weight are greater than a positioning signal fusing weight.

7. The vehicle positioning system for the container yard vehicle as claimed in claim 2, further comprising:
a mobile device, communicatively connected to the cloud server, and generating a positioning signal;
wherein when the cloud server further receives the positioning signal from the mobile device, the cloud server fuses the first gate sensing signal, the second gate sensing signal, the third gate sensing signal, and the positioning signal to generate the first vehicle identity information and the first vehicle positioning information;
wherein the first gate signal fusing weight, the second gate signal fusing weight, and the third gate signal fusing weight are greater than a positioning signal fusing weight.

8. The vehicle positioning system for the container yard vehicle as claimed in claim 3, further comprising:
mobile device, communicatively connected to the cloud server, and generating a positioning signal;
wherein when the cloud server further receives the positioning signal from the mobile device, the cloud server fuses the first queuing area sensing signal, the second queuing area sensing signal, and the positioning signal for determining whether the second vehicle identity information is the first vehicle identity information;
wherein when the second vehicle identity information is the first vehicle identity information, the cloud server transmits the notification signal for scheduling;
wherein the first queuing area signal fusing weight and the second queuing area signal fusing weight are greater than a positioning signal fusing weight.

9. The vehicle positioning system for the container yard vehicle as claimed in claim 4, further comprising:
a mobile device, communicatively connected to the cloud server, and generating a positioning signal;
wherein when the cloud server further receives the positioning signal from the mobile device, the cloud server fuses the first queuing area sensing signal, the second queuing area sensing signal, the third queuing area sensing signal, and the positioning signal for determining whether the second vehicle identity information is the first vehicle identity information;
wherein when the second vehicle identity information is the first vehicle identity information, the cloud server transmits the notification signal for scheduling;
wherein the first queuing area signal fusing weight, the second queuing area signal fusing weight, and the third queuing area signal fusing weight are greater than a positioning signal fusing weight.

10. The vehicle positioning system for the container yard vehicle as claimed in claim 5, further comprising:
a mobile device, communicatively connected to the cloud server, and generating a positioning signal;
wherein when the cloud server further receives the positioning signal from the mobile device, the cloud server fuses the first gantry crane sensing signal, the second gantry crane sensing signal, and the positioning signal for determining whether the third vehicle identity information is the first vehicle identity information;
wherein when the third vehicle identity information is the first vehicle identity information, the cloud server transmits the notification signal for scheduling;
wherein the first gantry crane signal fusing weight and the second gantry crane signal fusing weight are greater than a positioning signal fusing weight.

11. A vehicle positioning method for a container yard vehicle, executed by a cloud server, and comprising steps of:
receiving a first gate sensing signal and a second gate sensing signal from a gate checking device;
fusing the first gate sensing signal and the second gate sensing signal to generate first vehicle identity information and first vehicle positioning information corresponding to a first container yard vehicle;
wherein a first gate signal fusing weight of the first gate sensing signal is greater than a second gate signal fusing weight of the second gate sensing signal.

12. The vehicle positioning method for the container yard vehicle as claimed in claim 11, further comprising steps of:
when further receiving a third gate sensing signal, fusing the first gate sensing signal, the second gate sensing signal, and the third gate sensing signal;
generating the first vehicle identity information and the first vehicle positioning information;
wherein the first gate signal fusing weight and the second gate signal fusing weight are greater than a third gate signal fusing weight of the third gate sensing signal.

13. The vehicle positioning method for the container yard vehicle as claimed in claim 11, further comprising steps of:
receiving a first queuing area sensing signal and a second queuing area sensing signal from a queuing area checking device;
fusing the first queuing area sensing signal and the second queuing area sensing signal;
generating second vehicle identity information for determining whether the second vehicle identity information of a second container yard vehicle is the first vehicle identity information, and determining whether the second container yard vehicle is positioned in a lane;
when the second vehicle identity information is the first vehicle identity information and the second container yard vehicle is positioned in the lane, transmitting a notification signal for scheduling;
wherein a first queuing area signal fusing weight of the first queuing area sensing signal is greater than a second queuing area signal fusing weight of the second queuing area sensing signal.

14. The vehicle positioning method for the container yard vehicle as claimed in claim 13, further comprising steps of:
when further receiving a third queuing area sensing signal, fusing the first queuing area sensing signal, the second queuing area sensing signal, and the third queuing area sensing signal;
determining whether the second vehicle identity information is the first vehicle identity information;
when the second vehicle identity information is the first vehicle identity information, transmitting the notification signal for scheduling;
wherein the first queuing area signal fusing weight and the second queuing area signal fusing weight are greater than a third queuing area signal fusing weight of the third queuing area sensing signal.

15. The vehicle positioning method for the container yard vehicle as claimed in claim 11, further comprising steps of:
receiving a first gantry crane sensing signal and a second gantry crane sensing signal from a gantry crane checking device;
fusing the first gantry crane sensing signal and the second gantry crane sensing signal;
generate third vehicle identity information for determining whether the third vehicle identity information is the first vehicle identity information;
when the third vehicle identity information is the first vehicle identity information, transmitting the notification signal for scheduling;
wherein a first gantry crane signal fusing weight of the first gantry crane sensing signal is greater than a second gantry crane signal fusing weight of the second gantry crane sensing signal.

16. The vehicle positioning method for the container yard vehicle as claimed in claim 11, further comprising steps of:
when further receiving a positioning signal from a mobile device, fusing the first gate sensing signal, the second gate sensing signal, and the positioning signal;
generating the first vehicle identity information and the first vehicle positioning information;
wherein the first gate signal fusing weight and the second gate signal fusing weight are greater than a positioning signal fusing weight.

17. The vehicle positioning method for the container yard vehicle as claimed in claim 12, further comprising steps of:
when further receiving a positioning signal from a mobile device, fusing the first gate sensing signal, the second gate sensing signal, the third gate sensing signal, and the positioning signal;
generating the first vehicle identity information and the first vehicle positioning information;
wherein the first gate signal fusing weight, the second gate signal fusing weight, and the third gate signal fusing weight are greater than a positioning signal fusing weight.

18. The vehicle positioning method for the container yard vehicle as claimed in claim 13, further comprising steps of:
when further receiving a positioning signal from a mobile device, fusing the first queuing area sensing signal, the second queuing area sensing signal, and the positioning signal;
determining whether the second vehicle identity information is the first vehicle identity information;
when the second vehicle identity information is the first vehicle identity information, transmitting the notification signal for scheduling;
wherein the first queuing area signal fusing weight and the second queuing area signal fusing weight are greater than a positioning signal fusing weight.

19. The vehicle positioning method for the container yard vehicle as claimed in claim 14, further comprising steps of:
when further receiving a positioning signal from a mobile device, fusing the first queuing area sensing signal, the second queuing area sensing signal, the third queuing area sensing signal, and the positioning signal;
determining whether the second vehicle identity information is the first vehicle identity information;
when the second vehicle identity information is the first vehicle identity information, transmitting the notification signal for scheduling;
wherein the first queuing area signal fusing weight, the second queuing area signal fusing weight, and the third queuing area signal fusing weight are greater than a positioning signal fusing weight.

20. The vehicle positioning method for the container yard vehicle as claimed in claim 15, further comprising steps of:
when further receiving a positioning signal from a mobile device, fusing the first gantry crane sensing signal, the second gantry crane sensing signal, and the positioning signal;
determining whether the third vehicle identity information is the first vehicle identity information;
when the third vehicle identity information is the first vehicle identity information, transmitting the notification signal for scheduling;
wherein the first gantry crane signal fusing weight and the second gantry crane signal fusing weight are greater than a positioning signal fusing weight.
